(19) United States
(12) Patent Application Publication
(10) Pub. No.: US 2025/0292288 A1
(43) Pub. Date: Sep. 18, 2025

(54) OPTIMIZATION-BASED RESOURCE ALLOCATION IN SPONSORED SEARCH

(71) Applicant: eBay Inc., San Jose, CA (US)

(72) Inventors: Qinyi Chen, Cambridge, MA (US); Ha Nguyen Phuong, San Jose, CA (US); Djordje Gligorijevic, Fremont, CA (US); Zhenke Xi, San Jose, CA (US); Sheng Shen, San Jose, CA (US); Arnab Borah, Berlin (DE); Gajanan Adalinge, Santa Clara, CA (US); Abraham Bagherjerian, Palo Alto, CA (US)

(21) Appl. No.: 18/934,542

(22) Filed: Nov. 1, 2024

Related U.S. Application Data
(60) Provisional application No. 63/566,649, filed on Mar. 18, 2024.

(51) Int. Cl. G06Q 30/0273

(52) U.S. Cl. CPC G06Q 30/0275

(57) ABSTRACT

A system and method for optimizing resource allocation in a real-time online auction system of a publication application is described. The method includes receiving campaign data including a total budget, target resource utilization curve, and maximum bid for each auction opportunity of the publication application, maintaining, in a memory, a dynamic adjustment factor for each campaign, applying a resource conservation algorithm by calculating an adjusted bid using the dynamic adjustment factor, tracking, in real-time, resource utilization for each campaign for the publication application, updating the dynamic adjustment factor based on a difference between target and actual resource utilization, to reduce computational load through adaptive bid adjustments, and outputting, to a network interface, the updated dynamic adjustment factor and the adaptive bid adjustments for use in subsequent auctions, to balance resource utilizations across multiple time periods.

### RELATED APPLICATION

The present application claims priority from U.S. Provisional Patent Application Ser. No. 63/566,649 filed Mar. 18, 2024, which is hereby incorporated by reference in its entirety.

### TECHNICAL FIELD

The subject matter disclosed herein generally relates to systems and methods for optimizing resource allocation in sponsored search environments. More specifically, the subject matter pertains to techniques for dynamically adjusting allocation configuration to maximize utility and platform efficiency over time.

### BACKGROUND

Sponsored search environments face significant technical challenges in optimizing resource allocation and auction participation. One issue is the premature depletion of resources due to suboptimal bidding strategies. This occurs when participants specify maximum bids and targeting strategies in advance, without considering the dynamic nature of user engagement throughout the day. As a result, participants may exhaust their resources early, missing out on high-value opportunities during peak traffic periods.

Another technical problem is the difficulty in maintaining consistent resource utilization patterns across all participants. This inconsistency leads to inefficiencies in the auction system, where some participants are unable to compete due to depleted resources while others underutilize their allocated budgets. The challenge lies in developing algorithms that can dynamically adjust participation rates and bid values to optimize resource allocation over time.

Furthermore, the current auction mechanisms struggle to balance the competing objectives of maximizing platform efficiency and individual participant utility. This creates a technical hurdle in designing allocation strategies that can simultaneously satisfy the needs of diverse participants while ensuring overall system performance. The complexity is compounded by the need to process and respond to real-time data on auction outcomes, user behavior, and resource utilization across a large number of concurrent auctions.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a publication system that, in one example embodiment, is provided as part of a networked system.

FIG. 3 illustrates an adaptive pacing configuration application in accordance with one example embodiment.

FIG. 4 is a block diagram illustrating an example of a budget pacing controller in accordance with one example embodiment.

FIG. 5 illustrates a routine 500 for optimizing resource allocation in a real-time online auction system of a publication application, in accordance with one embodiment.

FIG. 6 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The following document pertains to a computer-implemented method and system for optimizing resource allocation in real-time online auction environments, especially in the realm of sponsored search advertising. The system aims to efficiently manage and distribute limited advertising budgets across multiple time periods within a dynamic, high-volume auction system.

In traditional online advertising systems, advertisers often grapple with the issue of depleting their budgets prematurely, causing them to miss out on opportunities during high-traffic or high-conversion periods. This not only leads to suboptimal advertiser performance but also results in system-wide inefficiencies in ad slot allocation and pricing. Additionally, managing thousands of campaigns simultaneously in real-time presents significant challenges in terms of computational complexity, system performance, and scalability.

The technical solution provided by the described system is an adaptive, optimization-based budget pacing algorithm that dynamically adjusts bids in real-time to balance resource utilization across multiple time periods. For instance, the system maintains a dynamic adjustment factor for each campaign, which is continuously updated based on the variance between target and actual resource utilization. This approach allows for precise control over budget expenditure while adapting to changing auction conditions throughout the day.

The system addresses technical challenges and improves computer system operation in the following ways:

Computational Efficiency: The algorithm uses a computationally efficient formula to update the dynamic adjustment factor. This reduces processing time and computational load, which is crucial in high-frequency, real-time auctions.

Adaptive Resource Allocation: The algorithm continuously optimizes resource allocation by balancing current and future opportunities, reducing the need for manual intervention and allowing for more efficient use of system resources.

Improved System Stability: The algorithm maintains consistent competition levels throughout the day and balances ad exposure across different time periods, enhancing overall system stability and user experience.

Scalability: The system selectively applies the resource conservation algorithm to campaigns based on their utilization patterns, focusing computational resources where they are most needed, improving scalability.

Self-Optimization: The system integrates a feedback mechanism for updating adjustment signals based on real-time utilization data, creating a self-optimizing system that continuously improves its performance and efficiency over time.

Addressing these technical challenges not only improves the performance of individual advertising campaigns but also enhances the overall efficiency, stability, and scalability of the online auction system. This results in a more effective allocation of computational resources, improved system responsiveness, and ultimately, a better experience for both advertisers and users of the sponsored search platform.

The present disclosure outlines an optimization-based budget pacing system for sponsored search advertising. This system dynamically adjusts bids in real-time to balance resource utilization across multiple time periods. Each advertising campaign maintains a dynamic adjustment factor (pacing multiplier) which is continuously updated based on the difference between target and actual spending.

The system operates by receiving campaign data, including total budget, target spending curve, and maximum bid for each impression. For each auction opportunity, the system applies a bid shading mechanism by calculating an adjusted bid using the pacing multiplier. Realized spending is tracked in real-time and the pacing multiplier is updated using a computationally efficient formula. This adaptive approach allows for fine-grained control over budget expenditure while adjusting to changing auction conditions throughout the day.

The updated pacing multiplier and shaded bid are then output for use in subsequent auctions, creating a feedback loop that continuously optimizes campaign performance and system efficiency.

In one example embodiment, a system and method for optimizing resource allocation in a real-time online auction system of a publication application is described. The method includes receiving campaign data including a total budget, target resource utilization curve, and maximum bid for each auction opportunity of the publication application, maintaining, in a memory, a dynamic adjustment factor for each campaign, applying a resource conservation algorithm by calculating an adjusted bid using the dynamic adjustment factor, tracking, in real-time, resource utilization for each campaign for the publication application, updating the dynamic adjustment factor based on a difference between target and actual resource utilization, to reduce computational load through adaptive bid adjustments, and outputting, to a network interface, the updated dynamic adjustment factor and the adaptive bid adjustments for use in subsequent auctions, to balance resource utilizations across multiple time periods.

As a result, one or more of the methodologies described herein facilitate solving the technical problem of balance resource utilization across multiple time periods. As such, one or more of the methodologies described herein may obviate a need for certain efforts or computing resources that otherwise would be involved in system-wide inefficiencies in managing thousands of campaigns simultaneously in real-time. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

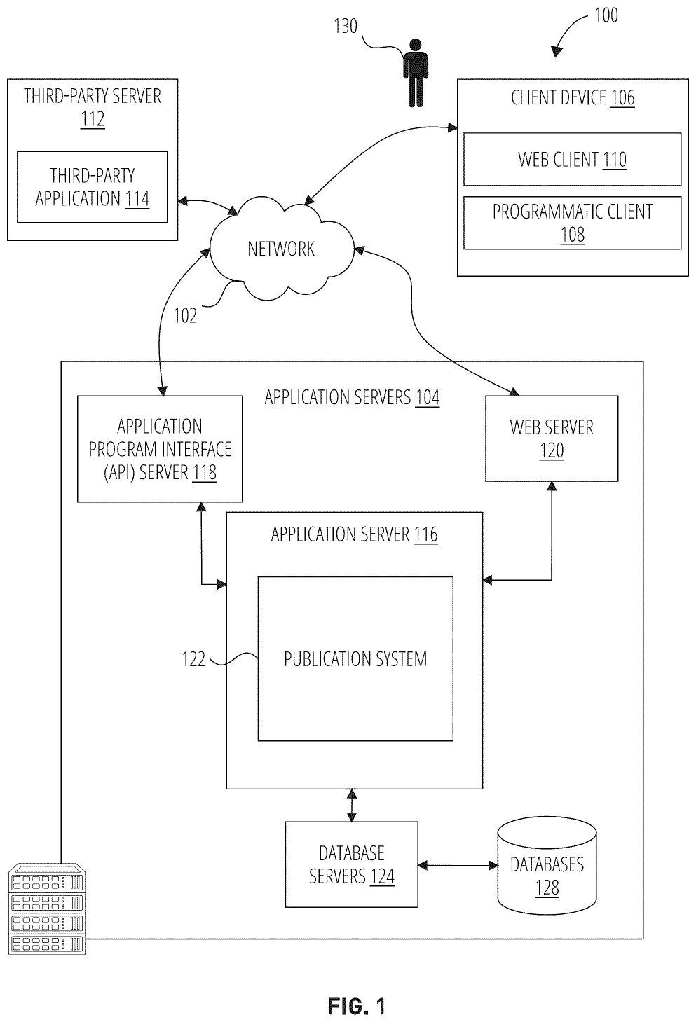

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. The client device 106 may also be referred to as a mobile device. The client device 106 hosts and executes a web client 110 (e.g., a browser), a programmatic client 108 (e.g., an “app”).

An Application Program Interface (API) server 118 and a web server 120 provide respective programmatic and web interfaces to application servers 104. A specific application server 116 hosts a publication system 122, which includes Components, modules and/or applications.

The publication system 122 may refer to an online publication platform. Examples of online publication platforms include but are not limited to, e-commerce platforms and social media platforms. In one example, the publication system 122 includes an e-commerce platform that provides a number of marketplace functions and services to users who access the application servers 104.

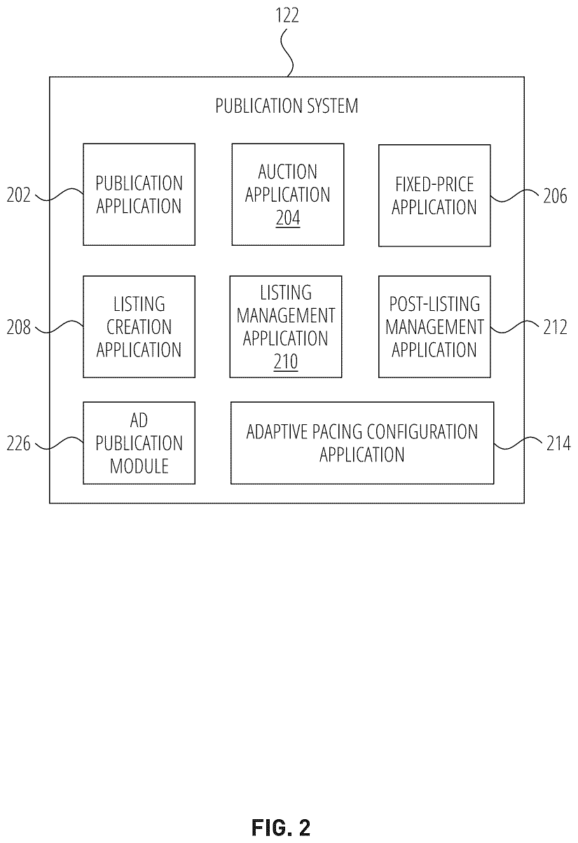

Further, while the network environment 100 shown in FIG. 1 employs a client-server architecture, the embodiments are, of course, not limited to such an architecture, and could equally well find application in a distributed, or peer-to-peer, architecture system, for example. Features of the publication system 122 could also be implemented as standalone software programs, which do not necessarily have networking capabilities. In another example, a machine learning analysis may be performed at the publication system 122, at the programmatic client 108, or at another system (e.g., third-party server 112). The publication system 122 is described in more detail below with respect to FIG. 2.

The web client 110 accesses the various publication system 122 via the web interface supported by the web server 120. Similarly, the programmatic client 108 accesses the various services and functions provided by the publication system 122 via the programmatic interface provided by the Application Program Interface (API) server 118. The programmatic client 108 may, for example, be a seller application (e.g., cBay Application developed by eBay Inc., of San Jose, California) to enable the user 130 to take pictures of items, author, and manage listings on the network environment 100 in an offline manner, and to perform batch-mode communications between the programmatic client 108 and the application servers 104.

FIG. 1 also illustrates a third-party application 114 executing on a third-party server 112 as having programmatic access to the application servers 104 via the programmatic interface provided by the Application Program Interface (API) server 118. For example, the third-party application 114 may, utilizing information retrieved from the application server 116, support one or more features or functions on a website hosted by a third party. The third-party website may, for example, provide one or more ML analysis, promotional, marketplace, or payment functions that are supported by the relevant applications of the application servers 104.

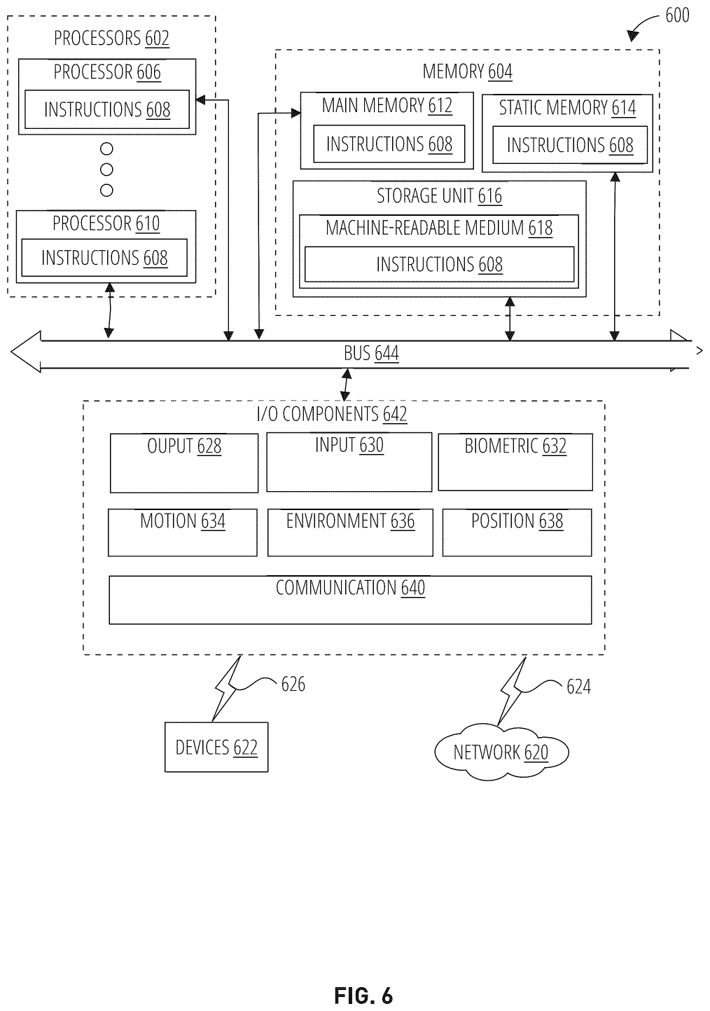

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

FIG. 2 is a block diagram illustrating the publication system 122 that, in one example embodiment, are provided as part of the network environment 100. The publication system 122 may be hosted on dedicated or shared server machines (not shown) that are communicatively coupled to enable communications between or among server machines. The publication system 122 themselves are communicatively coupled (e.g., via appropriate interfaces) to each other and to various data sources, so as to allow information to be passed between or among the publication system 122 or so as to allow the publication system 122 to share and access common data. The publication system 122 may furthermore access one or more databases 128 via the database servers 124.

The publication system 122 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 122 is shown to include a publication application 202, an auction application 204, a fixed-price application 206, a listing creation application 208, a listing management application 210, a post-listing management application 212, and an adaptive pacing configuration application 214.

The publication application 202 includes, for example, an e-commerce platform or a social media platform. The auction application 204 support auction-format listing and price setting mechanisms (e.g., English, Dutch, Vickrey, Chinese, Double, Reverse auctions, etc.). The various auction application 204 may also provide a number of features in support of such auction-format listings, such as a reserve price feature whereby a seller may specify a reserve price in connection with a listing and a proxy-bidding feature whereby a bidder may invoke automated proxy bidding.

The fixed-price application 206 supports fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with auction-format listings and allow a buyer to purchase goods or services, which are also being offered for sale via an auction, for a fixed price that is typically higher than the starting price of the auction.

The listing creation application 208 allows sellers to conveniently authorize listings pertaining to goods or services that they wish to transact via the application servers 104. In another example, the publication application 202 includes features for automatically generating listings from listing creation application 208. In another example, the listing creation application 208 receives metadata or attribute values for an item depicted in a photo taken with the client device 106, and generates a draft listing for the publication application 202 based on the metadata and attribute values.

The listing management application 210 allows sellers to manage such listings. Specifically, where a particular seller has authored and/or published a large number of listings, the management of such listings may present a challenge.

The listing management application 210 provides a number of features (e.g., auto-relisting, inventory level monitors, etc.) to assist the seller in managing such listings. The post-listing management application 212 also assists sellers with a number of activities that typically occur post-listing.

The ad publication module 226 enables selecting which ads to display based on the results of the auction process handled by the auction application 204. For example, the ad publication module 226 prepares the selected ads for display, including formatting and layout considerations to ensure proper presentation within the search results or other relevant pages.

In another example, the ad publication module 226 manages the timing of when ads are published, potentially in coordination with the adaptive pacing configuration application 214 to ensure optimal budget utilization throughout the day. Furthermore, the ad publication module 226 interfaces with listing management application 210 and post-listing management application 212, to ensure coherent ad management across the platform. The ad publication module 226 can also track the performance of published ads, feeding data back into the system for use by the adaptive pacing configuration application 214 and other optimization processes.

The adaptive pacing configuration application 214 implements the optimization-based budget pacing system described in the present application. The Adaptive Pacing Configuration Application 214 is performs the following functions:

Budget Pacing Controller: the adaptive pacing configuration application 214 implements the main logic for dynamically adjusting bids in real-time to balance resource utilization across multiple time periods.

Pacing Multiplier Management: adaptive pacing configuration application 214 maintains and updates the pacing multiplier (μk,t) for each campaign, which is used to calculate adjusted bids.

Bid Shading Mechanism: adaptive pacing configuration application 214 applies the bid shading formula (bk,i=vk,i/(1+μk,t)) to calculate adjusted bids for each impression opportunity.

Spend Tracking: The adaptive pacing configuration application 214 tracks realized spending (\tilde{z}k,t) for each campaign in real-time.

Pacing Multiplier Updates: adaptive pacing configuration application 214 updates the pacing multiplier using the formula μk, t+1=[μk,t−εk,t (ρk,tBk−\tilde{z}k,t)]+, where εk,t is the step size, ρk,t is the target spending rate, Bk is the total budget, and \tilde{z}k,t is the realized spending.

Integration with Auction System: the adaptive pacing configuration application 214 interfaces with the auction application 204 to provide adjusted bids for the ad auctions.

Data Analysis: the adaptive pacing configuration application 214 analyzes historical campaign performance data to optimize pacing strategies and identify campaigns that require adaptive pacing.

Feedback Mechanism: adaptive pacing configuration application 214 implements a feedback loop that continuously optimizes campaign performance and system efficiency based on real-time spending data.

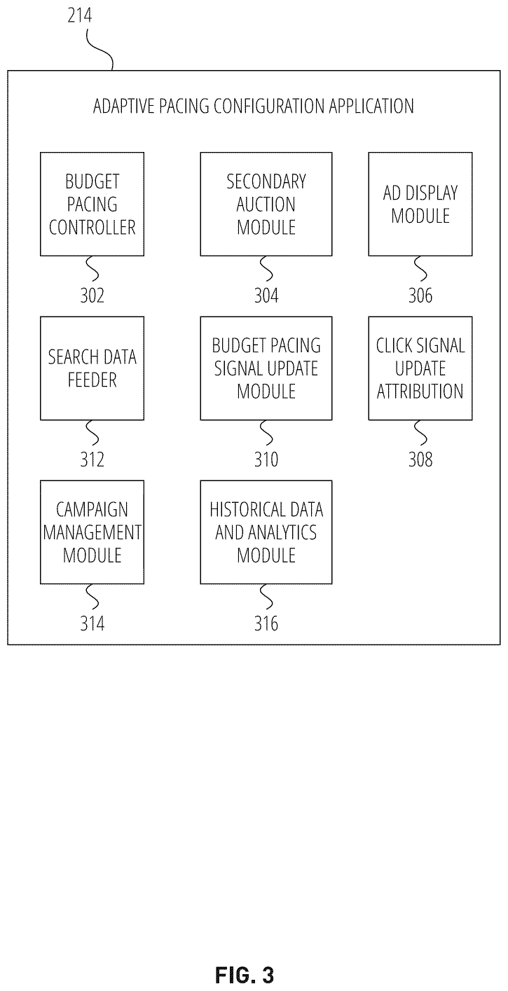

The adaptive pacing configuration application 214 is described in more detail below with respect to FIG. 3.

It should be noted that the term “web browser” as used in this disclosure shall be interpreted broadly to cover any application capable of displaying item attributes and rendering images from a web server. As such, this may include traditional web browsers as well as stand-alone applications (or apps) operating on mobile or other devices. For example, the web browser could be a traditional web browser such as Internet Explorer from Microsoft Corp., a stand-alone app such as a shopping application, a video player app, etc.

In another example where the web browser is a stand-alone app, it may be operating on, for example, a mobile device having a display and a camera. The techniques described herein could, therefore, be applied to an image obtained by the mobile device from an outside source, such as via the Internet, an image previously stored on the mobile device, or an image taken by the camera on the mobile device, potentially in real-time. Indeed, the techniques described herein can be applied to any device that is capable of obtaining a digital image and transmitting portions of that digital image to another device. Mobile devices are certainly one example, but others are possible as well, such as wearables and head-mounted devices.

FIG. 3 illustrates the adaptive pacing configuration application 214 in accordance with one example embodiment. The adaptive pacing configuration application 214 includes a budget pacing controller 302, a secondary auction module 304, an ad display module 306, a click signal update attribution 308, a budget pacing signal update module 310, a search data feeder 312, a campaign management module 314, and a historical data and analytics module 316.

The budget pacing controller 302 is responsible for implementing the main logic of the AdaptivePacing algorithm. For example, the budget pacing controller 302 manages the dynamic adjustment of bids in real-time to balance resource utilization across multiple time periods.

In a specific example, the budget pacing controller 302 carries out the following functions: it initializes and maintains pacing multipliers (μk,t) for each campaign, applies the bid shading formula to calculate adjusted bids, updates pacing multipliers based on real-time spending data, and interfaces with other system components to receive campaign data and output adjusted bids.

The campaign management module 314 is responsible for handling the input and management of campaign data. This includes total budgets, target spending curves, and maximum bids for each impression. In one example embodiment, the campaign management module 314 performs the following functions: receives and processes campaign data, stores and updates campaign parameters, and provides campaign information to the budget pacing controller 302 as needed.

The budget pacing signal update module 310 tracks campaign spending and performance metrics in real-time. For instance, it monitors actual spending (\tilde{z}k,t) for each campaign, calculates the variance between target and actual spending, and delivers real-time spending data to the budget pacing controller 302 for pacing multiplier updates.

The historical data and analytics module 316 analyzes historical campaign performance data to optimize pacing strategies and identify campaigns that require adaptive pacing. In one example embodiment, the historical data and analytics module 316 performs the following functions: it collects and stores historical campaign performance data, analyzes the data to identify trends and patterns in spending behavior, and provides insights to the budget pacing controller 302 for strategy optimization.

The secondary auction module 304 interacts with the main auction application 204 to incorporate the adaptive pacing strategy into the auction process. In one example, the secondary auction module 304 carries out the following functions: receiving auction opportunities from the auction application 204, applying adjusted bids calculated by the budget pacing controller 302, and communicating auction results back to the budget pacing signal update module 310.

The ad display module 306 works in conjunction with the ad publication module 226 to ensure that the adaptive pacing strategy is reflected in the final ad display decisions. In one example embodiment, the ad display module 306 performs the following functions: receives adjusted bids and pacing signals from the budget pacing controller 302, interfaces with the ad publication module 226 to influence ad selection and display, and provides feedback on ad performance to the budget pacing signal update module 310.

The click signal update attribution 308 processes click data and attributes it to the appropriate campaigns, updating spending and performance metrics in real-time. In one example embodiment, the click signal update attribution 308 performs the following functions: receives and processes click data, attributes clicks to specific campaigns, calculates associated costs, and updates spending data in the budget pacing signal update module 310.

The search data feeder 312 serves as a link between the adaptive pacing configuration application 214 and the broader search engine infrastructure. It ensures that pacing decisions are incorporated into the overall search process. In one example, the search data feeder 312 receives pacing signals and adjusted bids from the budget pacing controller 302, formats and transmits this data to relevant parts of the search engine system, and facilitates the feedback loop by channeling performance data back to the adaptive pacing configuration application 214.

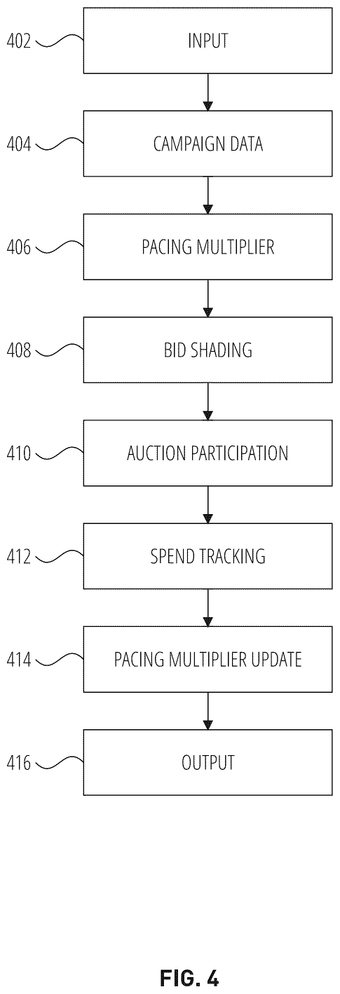

FIG. 4 is a block diagram illustrating an example of the budget pacing controller 302 in accordance with one example embodiment. The budget pacing controller 302 comprises an input 402, a campaign data 404, a pacing multiplier 406, a bid shading 408, an auction participation 410, a spend tracking 412, a pacing multiplier update 414, and an output 416.

Input Processing: The budget pacing controller 302 receives campaign data 404 for each advertiser, including:
Total Budget (Bk): The total amount allocated for the campaign over a specified period (typically daily)
Target Spending Curve (ρk,t): A function that determines the desired rate of budget expenditure over time
Maximum Bid (vk,i): The highest amount an advertiser is willing to pay for a particular impression

Pacing Multiplier Initialization: The budget pacing controller 302 maintains a pacing multiplier (μk,t) for each campaign. This pacing multiplier 406 is initialized at the beginning of the campaign and is continuously updated throughout the campaign's duration.

Bid Shading Mechanism: The Adaptive Pacing algorithm includes a bid shading 408 mechanism. For each impression opportunity, the budget pacing controller 302 calculates an adjusted bid (bk,i) using the formula:

$$b k , i = v k , i / ( 1 + μ k , t )$$

This adjustment allows the system to control the campaign's spending rate dynamically.

Auction Participation: The shaded bid (bk,i) is then used to participate in the ad auction. This step integrates the budget pacing strategy with the existing generalized second-price (GSP) auction mechanism of auction participation 410.

Spend Tracking: After each auction round, the budget pacing controller 302 tracks the realized spending (\tilde{z}k,t) for each campaign in real time to maintain accurate budget control.

Pacing Multiplier Update: At the end of each time interval (typically every minute), the budget pacing controller 302 updates the pacing multiplier using the formula:

$$μ k , t + 1 = [ μ k , t - ε k , t ( ρ k , tBk - \tilde{z} k , t ) ] +$$

Where:
εk, t is the step size for updates (typically set to 0.01)
ρk,tBk represents the target spend for the current interval
\tilde{z}k,t is the actual spend during the interval
[x]+ denotes the projection onto non-negative reals

Output Generation: The budget pacing controller 302 outputs two key pieces of information:
Updated Pacing Multiplier (μk,t+1): Used in the next round of bid adjustments
Shaded Bid (bk,i): The adjusted bid amount for each impression opportunity

The budget pacing controller 302's adaptive nature allows it to balance multiple objectives:
Ensuring advertisers' budgets are spent according to their desired spending curves
Maximizing the number of impressions and clicks for advertisers
Maintaining a competitive auction environment throughout the day
Optimizing platform revenue while respecting advertiser constraints.

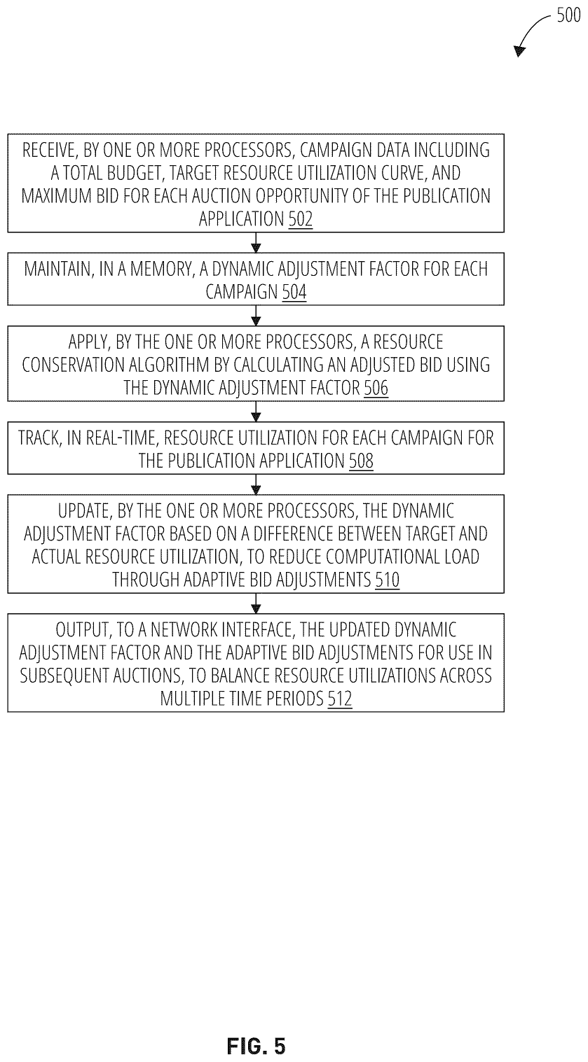

FIG. 5 illustrates an example routine 500 for optimizing resource allocation in a real-time online auction system of a publication application. Although the example routine 500 depicts a particular sequence of operations, the sequence may be altered without departing from the scope of the present disclosure. For example, some of the operations depicted may be performed in parallel or in a different sequence that does not materially affect the function of the routine 500. In other examples, different components of an example device or system that implements the routine 500 may perform functions at substantially the same time or in a specific sequence.

According to some examples, the method includes receiving, by one or more Processors, campaign data including a total budget, target resource utilization curve, and maximum bid for each auction opportunity of the publication application at block 502.

According to some examples, the method includes maintaining, in a memory, a dynamic adjustment factor for each campaign at block 504.

According to some examples, the method includes applying, by the one or more Processors, a resource conservation algorithm by calculating an adjusted bid using the dynamic adjustment factor at block 506.

According to some examples, the method includes tracking, in real-time, resource utilization for each campaign for the publication application at block 508.

According to some examples, the method includes updating, by the one or more Processors, the dynamic adjustment factor based on a difference between target and actual resource utilization, to reduce computational load through adaptive bid adjustments at block 510.

According to some examples, the method includes outputting, to a network interface, the updated dynamic adjustment factor and the adaptive bid adjustments for use in subsequent auctions, to balance resource utilizations across multiple time periods at block 512.

FIG. 6 is a diagrammatic representation of the machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include Processors 602, memory 604, and I/O Components 642, which may be configured to communicate with each other via a bus 644. In an example embodiment, the Processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a Processor 606 and a Processor 610 that execute the instructions 608. The term “processor” is intended to include multi-core processors that may comprise two or more independent processors (sometimes referred to as “cores”) that may execute instructions contemporaneously. Although FIG. 6 shows multiple Processors 602, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the Processors 602 via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the Processors 602 (e.g., within the processor's cache memory), or any suitable combination thereof, during execution thereof by the machine 600.

The I/O Components 642 may include a wide variety of Components to receive input, provide output, produce output, transmit information, exchange information, capture measurements, and so on. The specific I/O Components 642 that are included in a particular machine will depend on the type of machine. For example, portable machines such as mobile phones may include a touch input device or other such input mechanisms, while a headless server machine will likely not include such a touch input device. It will be appreciated that the I/O Components 642 may include many other components that are not shown in FIG. 6. In various example embodiments, the I/O Components 642 may include output Components 628 and input Components 630. The output Components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input Components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O Components 642 may include biometric Components 632, motion Components 634, environmental Components 636, or position Components 638, among a wide array of other Components. For example, the biometric Components 632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 634 include acceleration sensor components (e.g., accelerometer), gravitation sensor components, rotation sensor components (e.g., gyroscope), and so forth. The environmental Components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position Components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O Components 642 further include communication Components 640 operable to couple the machine 600 to a network 620 or devices 622 via a coupling 624 and a coupling 626, respectively. For example, the communication Components 640 may include a network interface component or another suitable device to interface with the network 620. In further examples, the communication Components 640 may include wired communication components, wireless communication components, cellular communication components, Near Field Communication (NFC) components, Bluetooth® components (e.g., Bluetooth®) Low Energy), Wi-Fi® components, and other communication components to provide communication via other modalities. The devices 622 may be another machine or any of a wide variety of peripheral devices (e.g., a peripheral device coupled via a USB).

Moreover, the communication Components 640 may detect identifiers or include Components operable to detect identifiers. For example, the communication Components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication Components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, and/or memory of the Processors 602) and/or storage unit 616 may store one or more sets of instructions and data structures (e.g., software) embodying or used by any one or more of the methodologies or functions described herein. These instructions (e.g., the instructions 608), when executed by Processors 602, cause various operations to implement the disclosed embodiments.

The instructions 608 may be transmitted or received over the network 620, using a transmission medium, via a network interface device (e.g., a network interface Component included in the communication Components 640) and using any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Examples

Example 1 is a computer-implemented method for optimizing resource allocation in a real-time online auction system of a publication application, comprising: receiving, by one or more processors, campaign data including a total budget, target resource utilization curve, and maximum bid for each auction opportunity of the publication application; maintaining, in a memory, a dynamic adjustment factor for each campaign; applying, by the one or more processors, a resource conservation algorithm by calculating an adjusted bid using the dynamic adjustment factor; tracking, in real-time, resource utilization for each campaign for the publication application; updating, by the one or more processors, the dynamic adjustment factor based on a difference between target and actual resource utilization, to reduce computational load through adaptive bid adjustments; and outputting, to a network interface, the updated dynamic adjustment factor and the adaptive bid adjustments for use in subsequent auctions, to balance resource utilizations across multiple time periods.

In Example 2, the subject matter of Example 1 includes, conducting, by the one or more processors, a multi-slot auction using the adjusted bids; and determining, in real-time, optimal resource allocation and pricing based on auction results.

In Example 3, the subject matter of Examples 1-2 includes, implementing, by the one or more processors, a minimum-utilization constraint by limiting a specified percentage of the resource utilizations; and adjusting the dynamic adjustment factor update by balancing resource conservation objectives and system performance goals, and optimizing system resource allocation.

In Example 4, the subject matter of Examples 1-3 includes, analyzing, by the one or more processors, historical performance data; identifying campaigns with constrained resources or a high likelihood of resource depletion; and selectively applying the resource conservation algorithm to campaigns based on their utilization patterns by optimizing system performance and reducing unnecessary computations.

In Example 5, the subject matter of Example 4 includes, wherein selectively applying the resource conservation algorithm comprises: applying the resource conservation algorithm only to campaigns that have utilized over a predetermined percentage of their resources in previous periods by reallocating focusing computational resources on the campaigns that require active management.

In Example 6, the subject matter of Examples 1-5 includes, dynamically adjusting bids throughout a specified time period to maintain consistent competition levels; and balancing the resource allocation across different time periods to improve system stability and user experience.

In Example 7, the subject matter of Examples 1-6 includes, wherein the target resource utilization curve is based on one of: a traffic curve, a uniform utilization curve, or a response rate curve, to allow for flexible adaptation to different system requirements.

In Example 8, the subject matter of Examples 1-7 includes, implementing the method within a resource management controller; integrating the resource management controller with an existing online auction system; and providing a feedback mechanism for updating adjustment signals based on real-time utilization data, by creating a self-optimizing system that continuously improves its performance and efficiency.

Example 9 is a computing apparatus comprising: a processor; and a memory storing instructions that, when executed by the processor, configure the apparatus to: receive, by one or more processors, campaign data including a total budget, target resource utilization curve, and maximum bid for each auction opportunity of the publication application; maintain, in a memory, a dynamic adjustment factor for each campaign; apply, by the one or more processors, a resource conservation algorithm by calculating an adjusted bid using the dynamic adjustment factor; track, in real-time, resource utilization for each campaign for the publication application; update, by the one or more processors, the dynamic adjustment factor based on a difference between target and actual resource utilization, to reduce computational load through adaptive bid adjustments; and output, to a network interface, the updated dynamic adjustment factor and the adaptive bid adjustments for use in subsequent auctions, to balance resource utilizations across multiple time periods.

In Example 10, the subject matter of Example 9 includes, wherein the instructions further configure the apparatus to: conduct, by the one or more processors, a multi-slot auction using the adjusted bids; and determine, in real-time, optimal resource allocation and pricing based on auction results.

In Example 9, the subject matter of Examples 9-10 includes, wherein the instructions further configure the apparatus to: implemen, by the one or more processors, a minimum-utilization constraint by limiting a specified percentage of the resource utilizations; and adjust the dynamic adjustment factor update by balancing resource conservation objectives and system performance goals, and optimizing system resource allocation.

In Example 12, the subject matter of Examples 9-9 includes, wherein the instructions further configure the apparatus to: analyze, by the one or more processors, historical performance data; identify campaigns with constrained resources or a high likelihood of resource depletion; and selectively apply the resource conservation algorithm to campaigns based on their utilization patterns by optimizing system performance and reducing unnecessary computations.

In Example 13, the subject matter of Example 12 includes, wherein selectively apply the resource conservation algorithm comprises: apply the resource conservation algorithm only to campaigns that have utilized over a predetermined percentage of their resources in previous periods by reallocating focusing computational resources on the campaigns that require active management.

In Example 14, the subject matter of Examples 9-13 includes, wherein the instructions further configure the apparatus to: dynamically adjust bids throughout a specified time period to maintain consistent competition levels; and balance the resource allocation across different time periods to improve system stability and user experience.

In Example 15, the subject matter of Examples 9-14 includes, wherein the target resource utilization curve is based on one of: a traffic curve, a uniform utilization curve, or a response rate curve, to allow for flexible adaptation to different system requirements.

Example 16 is a non-transitory computer-readable storage medium, the computer-readable storage medium including instructions that when executed by a computer, cause the computer to: receive, by one or more processors, campaign data including a total budget, target resource utilization curve, and maximum bid for each auction opportunity of the publication application; maintain, in a memory, a dynamic adjustment factor for each campaign; apply, by the one or more processors, a resource conservation algorithm by calculating an adjusted bid using the dynamic adjustment factor; track, in real-time, resource utilization for each campaign for the publication application; update, by the one or more processors, the dynamic adjustment factor based on a difference between target and actual resource utilization, to reduce computational load through adaptive bid adjustments; and output, to a network interface, the updated dynamic adjustment factor and the adaptive bid adjustments for use in subsequent auctions, to balance resource utilizations across multiple time periods.

Example 17 is at least one machine-readable medium including instructions that, when executed by processing circuitry, cause the processing circuitry to perform operations to implement of any of Examples 1-16.

Example 18 is an apparatus comprising means to implement of any of Examples 1-16.

Example 19 is a system to implement of any of Examples 1-16.

Example 20 is a method to implement of any of Examples 1-16.

What is claimed is:

1. A computer-implemented method for optimizing resource allocation in a real-time online auction system of a publication application, comprising:
receiving, by one or more processors, campaign data including a total budget, target resource utilization curve, and maximum bid for each auction opportunity of the publication application;
maintaining, in a memory, a dynamic adjustment factor for each campaign;
applying, by the one or more processors, a resource conservation algorithm by calculating an adjusted bid using the dynamic adjustment factor;
tracking, in real-time, resource utilization for each campaign for the publication application;
updating, by the one or more processors, the dynamic adjustment factor based on a difference between target and actual resource utilization, to reduce computational load through adaptive bid adjustments; and
outputting, to a network interface, the updated dynamic adjustment factor and the adaptive bid adjustments for use in subsequent auctions, to balance resource utilizations across multiple time periods.

2. The method of claim 1, wherein the dynamic adjustment factor is updated using a computationally efficient formula that reduces processing time: μk,t+1=[μk,t−εk,t(ρk,tBk−\tilde{z}k,t)]+ where μk,t is a current dynamic adjustment factor, εk,t is a step size, ρk,t is a target resource utilization rate, Bk is a total budget, and \tilde{z}k,t is a realized resource utilization.

3. The method of claim 1, further comprising:
conducting, by the one or more processors, a multi-slot auction using the adjusted bids; and
determining, in real-time, optimal resource allocation and pricing based on auction results.

4. The method of claim 1, further comprising:
implementing, by the one or more processors, a minimum-utilization constraint by limiting a specified percentage of the resource utilizations; and
adjusting the dynamic adjustment factor update by balancing resource conservation objectives and system performance goals, and optimizing system resource allocation.

5. The method of claim 4, wherein the minimum-utilization constraint is implemented by introducing a utilization factor γk, and updating both a dynamic adjustment factor μk and a utilization factor γk using computationally efficient formulas: μk,t+1=[μk,t−εk,t(ρk,tBk−\tilde{z}k,t)]+γk,t+1=[γk,t−ε′k,t(\tilde{z}k,t−αk·ρk,tBk)]+ where αk is a minimum percentage of resources to be utilized.

6. The method of claim 1, further comprising:
analyzing, by the one or more processors, historical performance data;
identifying campaigns with constrained resources or a high likelihood of resource depletion; and
selectively applying the resource conservation algorithm to campaigns based on their utilization patterns by optimizing system performance and reducing unnecessary computations.

7. The method of claim 6, wherein selectively applying the resource conservation algorithm comprises:
applying the resource conservation algorithm only to campaigns that have utilized over a predetermined percentage of their resources in previous periods by reallocating focusing computational resources on the campaigns that require active management.

8. The method of claim 1, further comprising:
dynamically adjusting bids throughout a specified time period to maintain consistent competition levels; and
balancing the resource allocation across different time periods to improve system stability and user experience.

9. The method of claim 1, wherein the target resource utilization curve is based on one of: a traffic curve, a uniform utilization curve, or a response rate curve, to allow for flexible adaptation to different system requirements.

10. The method of claim 1, further comprising:
implementing the method within a resource management controller;
integrating the resource management controller with an existing online auction system; and
providing a feedback mechanism for updating adjustment signals based on real-time utilization data, by creating a self-optimizing system that continuously improves its performance and efficiency.

11. A computing apparatus comprising:
a processor; and
a memory storing instructions that, when executed by the processor, configure the apparatus to:
receive, by one or more processors, campaign data including a total budget, target resource utilization curve, and maximum bid for each auction opportunity of the publication application;
maintain, in a memory, a dynamic adjustment factor for each campaign;
apply, by the one or more processors, a resource conservation algorithm by calculating an adjusted bid using the dynamic adjustment factor;
track, in real-time, resource utilization for each campaign for the publication application;
update, by the one or more processors, the dynamic adjustment factor based on a difference between target and actual resource utilization, to reduce computational load through adaptive bid adjustments; and
output, to a network interface, the updated dynamic adjustment factor and the adaptive bid adjustments for use in subsequent auctions, to balance resource utilizations across multiple time periods.

12. The computing apparatus of claim 11, wherein the dynamic adjustment factor is updated using a computationally efficient formula that reduces process time: μk,t+1=[μk,t−εk,t(ρk,tBk−\tilde{z}k,t)]+ where μk,t is a current dynamic adjustment factor, εk,t is a step size, ρk,t is a target resource utilization rate, Bk is a total budget, and \tilde{z}k,t is a realized resource utilization.

13. The computing apparatus of claim 11, wherein the instructions further configure the apparatus to:
conduct, by the one or more processors, a multi-slot auction using the adjusted bids; and
determine, in real-time, optimal resource allocation and pricing based on auction results.

14. The computing apparatus of claim 11, wherein the instructions further configure the apparatus to:
implement, by the one or more processors, a minimum-utilization constraint by limiting a specified percentage of the resource utilizations; and
adjust the dynamic adjustment factor update by balancing resource conservation objectives and system performance goals, and optimizing system resource allocation.

15. The computing apparatus of claim 14, wherein the minimum-utilization constraint is implemented by introducing a utilization factor γk, and update both a dynamic adjustment factor μk and a utilization factor γk using computationally efficient formulas: μk,t+1=[μk,t−εk,t(ρk,tBk−\tilde{z}k,t)]+γk,t+1=[γk,t−ε′k,t(\tilde{z}k,t−αk·ρk,tBk)]+ where αk is a minimum percentage of resources to be utilized.

16. The computing apparatus of claim 11, wherein the instructions further configure the apparatus to:
analyze, by the one or more processors, historical performance data;
identify campaigns with constrained resources or a high likelihood of resource depletion; and
selectively apply the resource conservation algorithm to campaigns based on their utilization patterns by optimizing system performance and reducing unnecessary computations.

17. The computing apparatus of claim 16, wherein selectively apply the resource conservation algorithm comprises:
apply the resource conservation algorithm only to campaigns that have utilized over a predetermined percentage of their resources in previous periods by reallocating focusing computational resources on the campaigns that require active management.

18. The computing apparatus of claim 11, wherein the instructions further configure the apparatus to:
dynamically adjust bids throughout a specified time period to maintain consistent competition levels; and
balance the resource allocation across different time periods to improve system stability and user experience.

19. The computing apparatus of claim 11, wherein the target resource utilization curve is based on one of: a traffic curve, a uniform utilization curve, or a response rate curve, to allow for flexible adaptation to different system requirements.

20. A non-transitory computer-readable storage medium, the computer-readable storage medium including instructions that when executed by a computer, cause the computer to:
receive, by one or more processors, campaign data including a total budget, target resource utilization curve, and maximum bid for each auction opportunity of the publication application;
maintain, in a memory, a dynamic adjustment factor for each campaign;
apply, by the one or more processors, a resource conservation algorithm by calculating an adjusted bid using the dynamic adjustment factor;
track, in real-time, resource utilization for each campaign for the publication application;
update, by the one or more processors, the dynamic adjustment factor based on a difference between target and actual resource utilization, to reduce computational load through adaptive bid adjustments; and
output, to a network interface, the updated dynamic adjustment factor and the adaptive bid adjustments for use in subsequent auctions, to balance resource utilizations across multiple time periods.
